(19) United States
(12) Patent Application Publication
(10) Pub. No.: US 2016/0140599 A1
(43) Pub. Date: May 19, 2016

(54) Automatic Discovery of High-Performance Features for Customer Lifetime Value Optimization via Low-Variance Random Projection

(71) Applicant: ADOBE SYSTEMS INCORPORATED, San Jose, CA (US)

(72) Inventors: Bruno Castro da Silva, Amherst, MA (US); Trung H. Bui, San Jose, CA (US)

(21) Appl. No.: 14/542,112

(22) Filed: Nov. 14, 2014

(51) Int. Cl. G06Q 30/02

(52) U.S. Cl. CPC G06Q 30/0242; G06Q 30/0269

(57) ABSTRACT

Techniques for automatic discovery of high-performance features for customer LTV optimization via low-variance random projection are described. In one or more implementations, a random projection matrix is generated that is usable to compress a dataset representing a plurality of features associated with one or more customers. Using a first subset of the plurality of features, a simulator is created to model customer behavior. In addition, a policy is trained to determine which advertisements to present to a new customer based on a second subset of the plurality of features. In implementations, the policy is trained by at least using the random projection matrix to compress the second subset of the plurality of features. Subsequently, a performance of the policy is evaluated using the simulator to determine a level of the performance of the policy. This process is repeated a number of times in order to evaluate several possible candidate transformations and compressions of the dataset, with the goal of autonomously discovering and identifying a new compressed set of high-performing features for use in LTV learning algorithms.

### BACKGROUND

Personalized marketing is the process by which a company targets visitors to a website with personalized content so that, with high probability, those visitors eventually buy one or more products. The goal of customer Lifetime Value (LTV) optimization algorithms is to analyze past recorded interactions with customers and create an optimized decision process for making real-time offers. Generally, customers are modeled via a large number of features (e.g., hundreds to thousands) that describe the customers, and a function referred to as a “policy” is constructed to map customer features to optimal actions. Here, actions correspond to possible choices of which content or offer may be presented to a user, e.g., current, new, or potential customer.

Conventional policy learning algorithms typically utilize a relatively small set of carefully constructed features so that optimal actions can be easily and quickly identified. Otherwise, the learning algorithms may involve an unreasonable amount of time to compute appropriate solutions. The quality of solutions heavily depends on the set of features used and so an expert (e.g., human) is typically tasked to carefully study the problem and manually design an effective feature representation. This, however, may be error-prone and time-consuming.

### SUMMARY

Techniques for automatic discovery of high-performance features for customer LTV optimization via low-variance random projection are described. The techniques described herein include an iterative process that generates a random projection, uses that random projection to generate multiple policies that are each evaluated using a different simulator to obtain an average performance of the random projection. Then, the process is repeated a number of times to compare average performances of a plurality of different random projections, and identify top-performing projections that can be used as input for a LTV learning algorithm. Each such random projection is capable of transforming a given set of baseline features into a transformed and compressed set of high-performance features for an LTV algorithm.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 is an illustration of an example implementation that is operable to employ techniques for automatic discovery of high-performance features for customer LTV optimization via low-variance random projection.

FIG. 3 is a flow diagram depicting a procedure in an example implementation in which a low-variance random projection is employed and evaluated.

FIG. 4 is a flow diagram depicting a procedure in an example implementation in which high-performance features are discovered via low-variance random projection.

FIG. 5 illustrates various components of an example device that can be implemented as any type of computing device as described herein to implement the techniques described herein.

### DETAILED DESCRIPTION

### Overview

Conventional techniques used for personalized marketing require an expert to manually design an effective feature representation of customers for a learning algorithm to develop effective strategies for showing advertisements to the customers. Considering the sheer amount of data used to represent customers, these conventional techniques may be error-prone and time-consuming.

Techniques are described involving automatic discovery of high-performance features for customer LTV optimization via low-variance random projection. Automatic discovery of which features to use as input to a LTV learning algorithm is performed in order to optimize the effectiveness of resultant LTV strategies for personalized marketing. In one or more implementations, a dataset is analyzed to autonomously discover how best to represent customer data to enable existing learning algorithms to rapidly calculate high-performance policies. The techniques described herein transform an arbitrary set of baseline features to obtain lower-dimensional representations which allow for faster policy learning, and high-performance transformed features which allow for improved policies to be learned. In implementations, the techniques described herein utilize several variations of the baseline features to construct new representations for the same data and determine which subset of the set of features will optimize the learning algorithm.

In one example, a random projection matrix is generated that is usable to compress a dataset representing a plurality of features associated with one or more customers. Using a first subset of the plurality of features, a simulator is created to model customer behavior. In addition, a policy is trained to determine which advertisements to present to a new customer based on a second subset of the plurality of features. In implementations, the policy is trained by at least using the random projection matrix to compress the second subset of the plurality of features. Subsequently, a performance of the policy is evaluated using the simulator to determine a level of the performance of the policy.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

As employed herein, the term “feature” is representative of an aspect associated with a customer. For example, features can describe a customer's location, age, income, height, marital status, education level, hair color, interests, hobbies, home ownership status, and so on. In implementations, features can describe frequency of logins to a website, length of visits, regularity of visits, and so on. Thus, the term “feature” can represent any of a variety of information associated with a customer.

As employed herein the term “random projection” is representative of a matrix, an array, or other data structure having a set of random numbers independently drawn from a given probability density function. In implementations, these values can correspond to Gaussian distribution with a mean of approximately zero and a variation approximately equal to one. In at least some implementations, the random projection can represent a baseline set of values that were determined by an expert. The term “random projection” is also referred to herein as a “compression operator” because the random projection is usable to compress a dataset into a relatively smaller dataset, examples of which are described below. Thus, the term “random projection” can represent a variety of arbitrary data structures.

### Example Environment

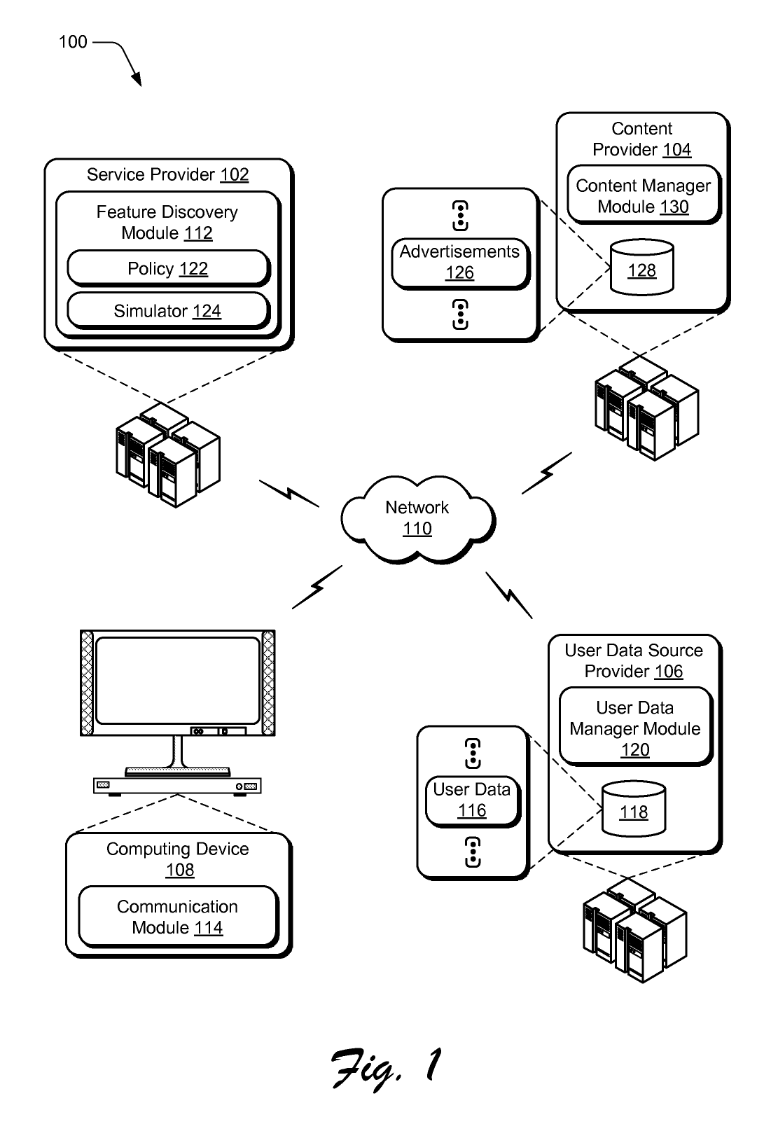

FIG. 1 is an illustration of an environment 100 in an example implementation that is operable to employ techniques described herein. The illustrated environment 100 includes a service provider 102, a content provider 104, a user data source provider 106, and a computing device 108 that are communicatively coupled via a network 110. Although illustrated separately, functionality represented by the service provider 102, the content provider 104, and the user data source provider 106 may also be combined into a single entity, may be further divided across other entities that are communicatively coupled via the network 110, and so on.

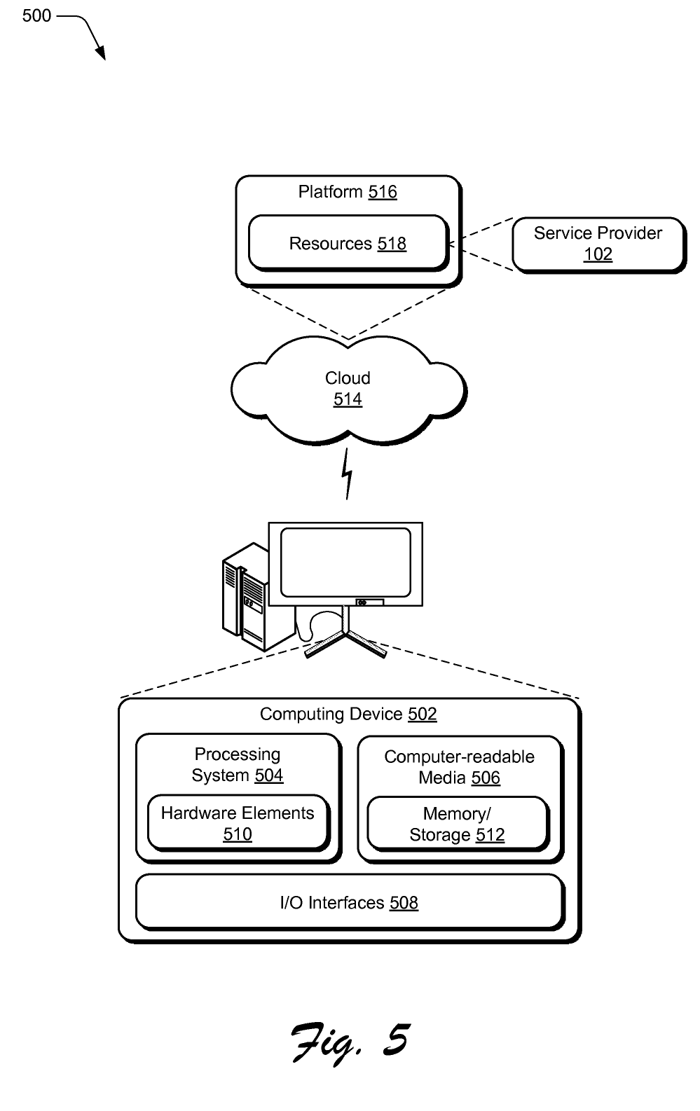

Computing devices that are used to implement the service provider 102, the content provider 104, and the user data source provider 106 may be configured in a variety of ways. Computing devices, for example, may be configured as a desktop computer, a laptop computer, a mobile device (e.g., assuming a handheld configuration such as a tablet or mobile phone), and so forth. Additionally, a computing device may be representative of a plurality of different devices, such as multiple servers utilized by a business to perform operations “over the cloud” as further described in relation to FIG. 5.

Although the network 110 is illustrated as the Internet, the network may assume a wide variety of configurations. For example, the network 110 may include a wide area network (WAN), a local area network (LAN), a wireless network, a public telephone network, an intranet, and so on. Further, although a single network 110 is shown, the network 110 may be representative of multiple networks.

In implementations, a user may interact with a computing device 108 having a communication module 114 that is configured to support communication via the network 110, such as with one or more services of the service provider 102. As such, the communication module 114 may be configured in a variety of ways. For example, the communication module 114 may be configured as a browser that is configured to “surf the web.” The communication module 114 may also be representative of network access functionality that may be incorporated as part of an application, e.g., to provide network-based functionality as part of the application, an operating system, and so on. Thus, functionality represented by the communication module 114 may be incorporated by the computing device 108 in a variety of different ways.

As part of the communication supported by the communication module 114, user data 116 may be generated, or otherwise obtained, that describes user interaction with one or more network services and/or websites, which is illustrated as stored in storage 118. Because user interactions may include a variety of different forms, user data 116 can likewise include a variety of forms to describe this interaction. The user data source provider 106, for instance, may include any of a variety of different websites or network services. A user data manager module 120 may be configured to monitor the interaction between the user, and the website or the network service. In addition, the user data manager module 120 may be configured to generate user data 116 that describes the monitored interaction, which may indicate frequency of logins to a website, length of visits, regularity of visits, navigations, selected links or other objects, selected advertisements, purchases, likes, dislikes, and so on.

The user data 116 may then be exposed by the user data source provider 106 for access by the feature discovery module 112 of the service provider 102 via the network 110, e.g., via one or more application programming interfaces. The feature discovery module 112 may then employ this user data 116 to generate a policy 122 that may be used to define a strategy for presenting advertisements to customers, and a simulator 124 to simulate user responses for evaluating the policy 122.

In implementations, the policy 122 can be used as a compressed set of features that describe customers, and which can be used by an LTV learning algorithm to generate a strategy for showing advertisements to a customer, such as advertisements 126 illustrated as stored in storage 128 at the content provider 104. A content manager module 130 may be configured to enable access to various advertisements 126 via the network 110. For example, the policy 122 can be used by an LTV learning algorithm and applied by the content manager module 130 to define a strategy for presenting advertisements 126 to the user. By generating a variety of policies 122 and evaluating those policies 122 to identify top-performing policies, only the top-performing policies are provided to the LTV learning algorithm to optimize, or otherwise increase the effectiveness of, LTV learning algorithms, which can result in presenting effective advertisements to users that may encourage the users to purchase a product. Further discussion of these and other examples may be found in the following section and is shown in corresponding figures.

### Example Implementation

The following discussion describes example implementations of automatic discovery of high-performance features for customer LTV optimization via low-variance random projection that can be employed to perform various aspects of techniques discussed herein. The example implementations may be employed in the environment 100 of FIG. 1, the system 500 of FIG. 5, and/or any other suitable environment.

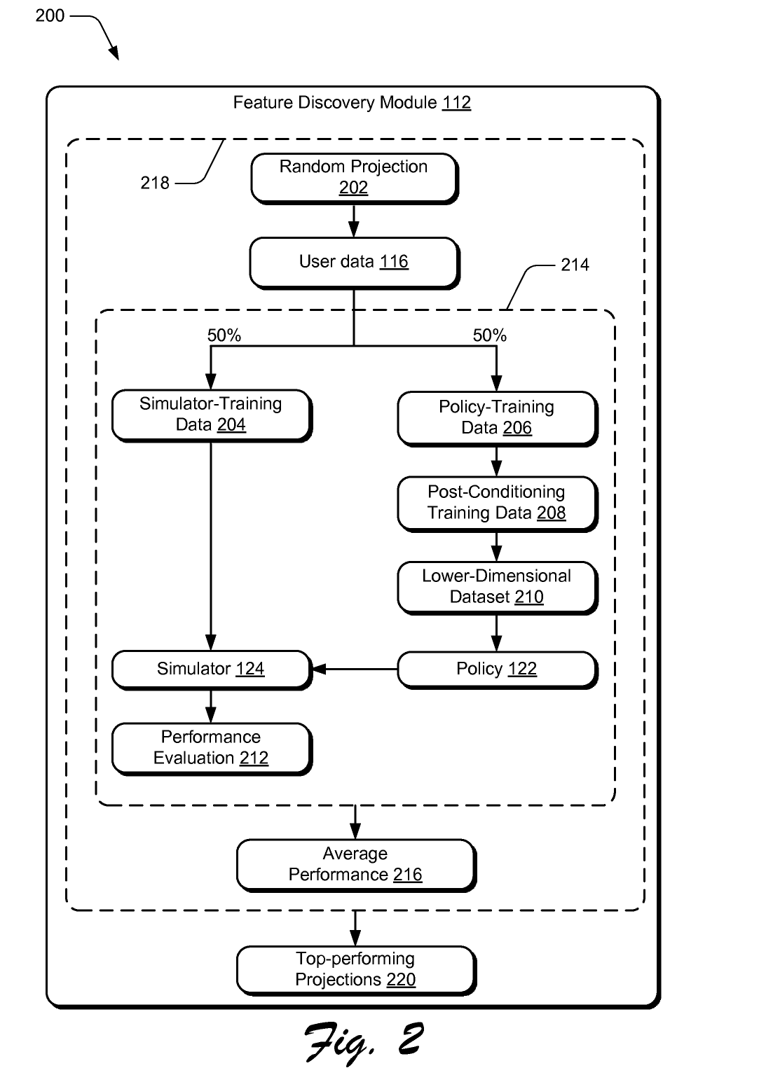

FIG. 2 is an illustration of an example implementation 200 that is operable to employ techniques for automatic discovery of high-performance features for customer LTV optimization via low-variance random projection. The illustrated implementation 200 includes a random projection, such as random projection 202 (e.g., compression operator), that represents a subset or combination of features describing one or more customers. As described above, the random projection 202 can include a matrix, an array, or other data structure having random values, with the values corresponding to a Gaussian distribution with a mean of zero and a variation equal to one. In implementations, the random projection 202 can be used to compress, or otherwise reduce, a dataset. For example, a dataset having a large number of features (e.g., 1,000) can be multiplied by the random projection 202 to generate a new representation for the dataset but with fewer features (e.g., 20).

In implementations, the random projection 202 can be used to compress a dataset of customer features to a low-dimensional dataset that solely includes relevant aspects of the customer. Other aspects, such as aspects that decrease the effectiveness of learned LTV strategies, are not included in the low-dimensional dataset. For example, a customer's location may be represented by two data points (e.g., latitude and longitude coordinates), which may be reduced to a single data point (e.g., zip code) that substantially includes the same information. With one feature instead of two, the learning algorithm can process the information relatively faster.

In addition, customer features that may be irrelevant to a particular LTV strategy (e.g., fail to improve the effectiveness of the LTV strategy) can be removed from the dataset. For example, if a customer's level of income has no effect on the type of books the customer purchases from a book distributor, then using the level of income feature as a factor in the LTV learning algorithm would not improve the strategies developed for the personalized marketing of that customer. Instead, using such an irrelevant feature merely increases processing times of the learning algorithm without increasing efficiency. Removing irrelevant features, however, can increase processing times of the learning algorithm by providing fewer inputs to the learning algorithm.

Other features can be modified or scaled to avoid weighting those features too heavily in the learning algorithm. For example, instead of representing age with a range from zero to one hundred, the age can be represented with a range from zero to one, where zero represents a person's birth and one represents the maximum age. Reducing or otherwise modifying the range of a feature can allow the feature to be more comparable with other features having similar ranges. Accordingly, the random projection 202 is usable to reduce the dataset by, for example, combining features, removing irrelevant features, and/or modifying features to decrease the processing time and increase the effectiveness of the LTV learning algorithms.

In addition, the illustrated example includes user data 116, such as user data obtained from the user data source provider 106 in FIG. 1. The user data 116 can include interactions between users and a website. These interactions can include any of a variety of interactions, such as logins, navigations, clicks, purchases, exits, visit duration, and so on. In addition, the user data 116 can include features that describe customers, such as demographic information, gender, age, income level, and so on. Thus, the user data 116 can include any of a variety of past interactions of the customer with the website as well as any of a variety of features describing the customer.

The user data 116 can be divided into at least two disjoint subsets of user data. A first subset of the user data 116 can be used to represent simulator-training data 204. In one example, approximately fifty percent of the user data 116 can be randomly selected to represent the simulator-training data 204. Using this simulator-training data 204, a simulator, such as simulator 124 from FIG. 1, can be generated to model user behavior. For example, the simulator 124 can predict or simulate how users might behave given a particular stimulus, such as whether the user will purchase a product based on the user being presented a particular advertisement.

While the first subset of the user data 116 is used as simulator-training data 204, a second subset of the user data 116 can be used as policy-training data 206. In the illustrated example, the remaining 50% of the user data 116 is selected to represent the policy-training data 206. The policy-training data 206 is then conditioned via a sequence of functions that transform the user data in the policy-training data 206 into values that are comparable across different interactions and/or features. For example, the functions used to condition the policy-training data 206 can include one or more transform, zscore, rescaling, and/or centering functions. The transformation of the policy-training data 206 outputs post-conditioning training data 208. In implementations, the post-conditioning training data 208 includes scaled customer interactions and/or features that are comparable with one another.

The post-conditioning training data 208 is then multiplied by the random projection 202 to produce a lower-dimensional dataset 210. For example, by multiplying or otherwise applying the random projection 202 to the post-conditioning training data 208, the number of values in the post-conditioning training data 208 is reduced to simplify the data used to describe each of the customers.

The lower-dimensional dataset 210 can then be used to train a policy, such as policy 122 from FIG. 1, that represents a strategy that is usable to determine which advertisements to present to customers. For example, the policy can be used to select automobile advertisements for customers between the ages of 20-30, college prep courses for lower-income customers, dolls for customers with young daughters, and so on. Thus, any of a variety of policies can be used to determine which advertisements to present to customers.

Once the policy 122 is generated, the policy 122 can be tested to determine the performance efficiency of the policy 122, by using the simulator 124. For example, the policy 122 can be tested, using the simulator 124, to generate a performance evaluation 212 that indicates how the customer would respond to decisions made by the policy 122. For example, the performance evaluation 212 may indicate that certain customers are, or are not, likely to purchase a product based on a particular advertisement or set of advertisements. In implementations, the performance evaluation 212 can include a score or other value that represents a relative efficiency of the policy.

In one or more implementations, the first and second subsets of the user data 116 are disjoint. Using disjoint subsets can avoid or reduce the likelihood of overfeeding the model. For example, if the same dataset is used to train both the simulator and the policy, without dividing the dataset into disjoint subsets, then the results may represent policies that are highly effective for only the specific customers in the dataset, but not for new customers. By splitting the dataset into disjoint subsets, a policy is trained on one subset that represents a first group of customers, and the policy is evaluated on other customers (e.g., customers represented by a different subset than the one subset) that were not used to determine that strategy.

In implementations, the performance evaluation 212 described above represents a first iteration of evaluating the random projection 202 using the user data 116. Additional iterations of operations within box 214 can be performed to evaluate multiple different policies for the random projection 202, each policy evaluated using a different simulator, where each policy and simulator are based on a unique subset of the user data 116. Accordingly, a number of iterations are performed in relation to randomly splitting the user data 116, training a new simulator 124, training a new policy 122, and evaluating the new policy 122 by using the new simulator 124.

Subsequently, an average performance 216 is calculated by averaging the performance evaluations 212 output by the number of iterations of box 214. Accordingly, the average performance 216 represents an average efficiency of the random projection 202, given the user data 116. In addition, the average performance 216 represents a score associated with the random projection 202 that is usable to compare the random projection 202 to additional random projections to identify top-performing projections.

In at least one approach, the process is repeated, as illustrated by box 218, by generating a new random projection and evaluating performance of the new random projection in a similar manner to output an average performance of the new random projection. Accordingly, a number of iterations are performed to generate multiple random projections, and evaluate each of the random projections using the above-described operations. In implementations, these iterations can be performed substantially in parallel, in sequence, or in any combination thereof.

Using the average performances 216 of the random projections 202, the top-performing projections 220 can be identified. In implementations, the average performances 216 can be ranked, or otherwise compared with one another, to identify which random projections 202 correspond to relatively highest scores. The top-performing random projections can then be used to determine which features to use to describe customers to allow for effective LTV strategies to be learned from the dataset. For example, the top-performing random projections represent low-dimensional sets of customer features that are relevant, high-performing, and appropriate to maximize efficiency of the LTV strategies learned from the dataset.

Accordingly, using the techniques described herein, the LTV learning algorithms can avoid using as input customer features that are irrelevant or that fail to improve the likelihood of a customer purchasing a product based on a particular advertisement. Likewise, learned LRV strategies can avoid using advertisements that are based on irrelevant customer features.

### Example Procedures

The following discussion describes techniques for automatic discovery of high-performance features for customer LTV optimization via low-variance random projection that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1.

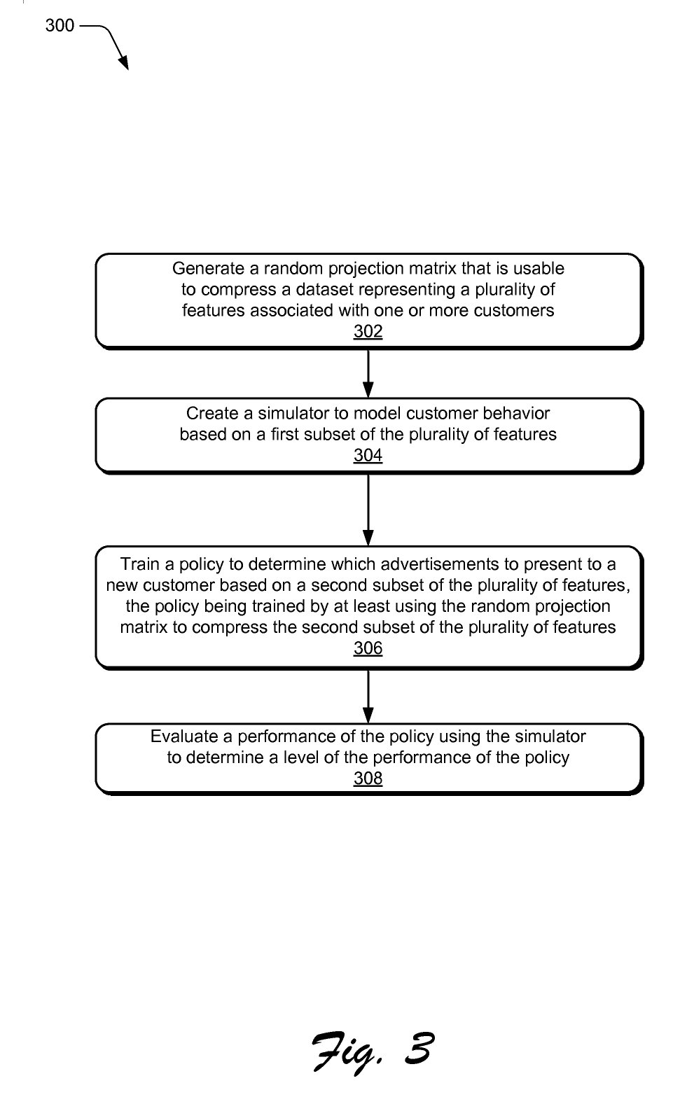

FIG. 3 is a flow diagram depicting a procedure 300 in an example implementation in which a low-variance random projection is employed and evaluated. A random projection matrix is generated that is usable to compress a dataset representing a plurality of features associated with one or more customers (block 302). For example, a data structure, array, matrix, or other dataset can be generated using an arbitrary set of values. In implementations, the random projection represents a subset of and/or a combination of features within a set of features that describe the customers.

A simulator is created to model customer behavior based on a first subset of the plurality of features (block 304). For example, the first subset of the plurality of features represents past customer interactions along with various descriptive information associated with the customer. Using this information, the simulator can be created to predict how a customer might behave given a particular input, examples of which are described above.

A policy is trained to determine which advertisements to present to a new customer based on a second subset of the plurality of features (block 306). In implementations, the policy is trained by at least using the random projection matrix to compress the second subset of the plurality of features. For example, applying the random projection matrix to the second subset can result in removal of some features, a modification of a format of some features, and/or a combination of multiple features into one feature. A resultant dataset is output that includes fewer features than the number of features in the second subset. This resultant dataset is used to train the policy. In implementations, the policy represents a strategy usable to determine which advertisements to present to current, new, or potential customers. Because the policy is trained using both a random subset of the dataset and a random projection (e.g., a random selection of features associated with customers), it is unknown whether the policy is an effective policy. Accordingly, the policy should be tested to determine its effectiveness and/or efficiency.

A performance of the policy is evaluated using the simulator to determine a level of the performance of the policy (block 308). For example, the policy is evaluated using the simulator to simulate user responses to a marketing strategy defined by the policy. In some implementations, the performance may be scored. This score can be used to determine an average performance of the random projection and/or determine how the average performance of the random projection compares to average performances of additional random projections.

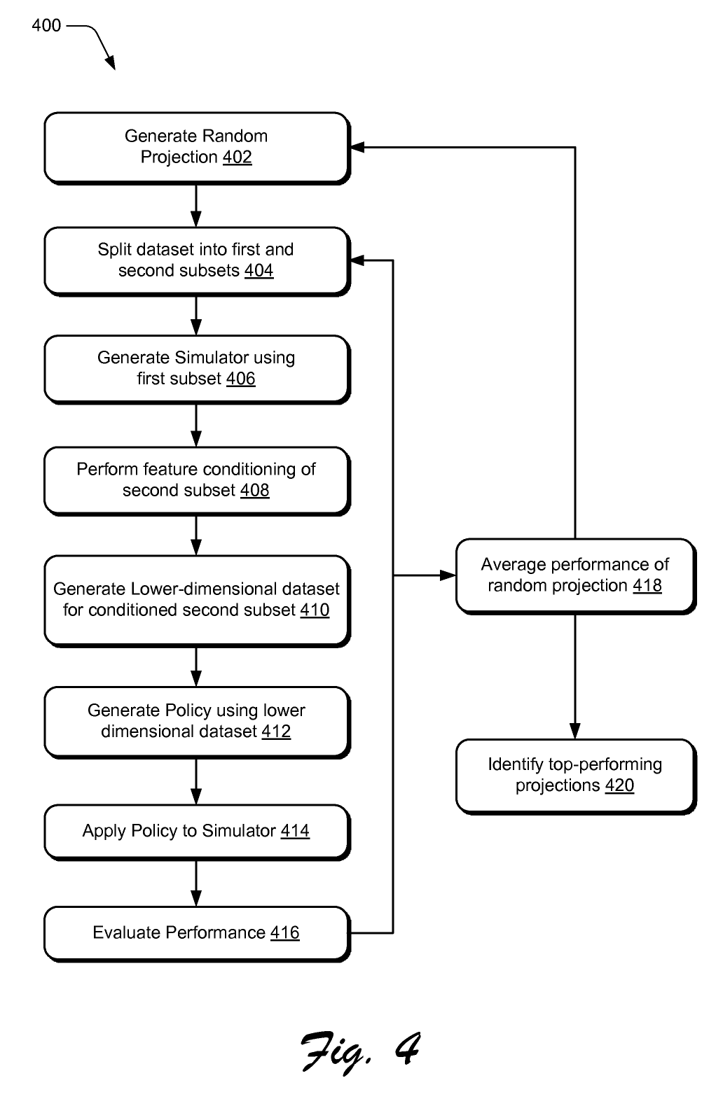

FIG. 4 is a flow diagram depicting a procedure 400 in an example implementation in which techniques described herein are employed. A random projection is generated (block 402). This step can be performed in any suitable way, examples of which are described above. A dataset is split into first and second subsets (block 404). For example, the dataset can include customer data such as features describing customers, and/or recorded customer interactions with a website and/or a network resource. These features and interactions can include a variety of different features and/or interactions, examples of which are described above. In implementations, the dataset can be split into two or more subsets that are disjoint, to reduce errors potentially caused by using the same values for both a simulator and a policy.

A simulator is generated using the first subset (block 406). For example, the first subset of the dataset is used to generate a simulator that is configured to simulate user behavior. As described above, the simulations can be usable to determine how a user would respond to certain policy decisions, such as whether the user will follow a link associated with a particular advertisement.

Feature conditioning of the second subset is performed (block 408). This step can be performed in any suitable way. For example, the second subset of the dataset can be transformed into values that are comparable across different interactions and/or features. In implementations, transformation of the values in the second subset includes scaling the values to cause the values to be similarly weighted when used to create a policy. In this way, a policy generator can avoid potential errors caused by weighting too heavily a particular value simply because it may have a different or relatively larger range than another value. In one example, a customer's age can be represented in a range from zero to one rather than zero to one hundred, where zero represents when the customer is born and one represents a maximum age.

A lower-dimensional dataset is generated for the conditioned second subset (block 410). For example, the conditioned second subset can be multiplied by the random projection previously generated at block 302 to reduce the number of features representing the customers. For instance, the lower-dimensional dataset includes a relatively fewer number of features describing the customers than the second subset. By using a reduced number of features describing the customer, policies can be trained faster and possibly more efficiently than traditional techniques.

A policy is generated using the lower-dimensional dataset (block 412). This step can be performance in any suitable way, examples of which are described above. The policy is applied to the simulator (block 414). For example, the policy is tested against the simulator to simulate user responses to the strategy defined by the policy. In implementations, the policy may define a strategy that shows irrelevant advertisements, which would result in customers not purchasing any products. Alternatively, the policy may define a strategy that shows advertisements relevant to users, and would result in customers purchasing one or more products.

Using the results of the simulator, the performance of the policy is evaluated (block 416). In implementations, the policy is evaluated based on simulated results output by the simulator. For example, the policy can be scored based on a number of simulated users that purchased a product based on the advertisements selected by the policy. The more simulated customers that purchase a product based on the advertisements defined by the policy, the more effective the policy.

The above-described process can be repeated (return to block 404) to define a new policy and evaluate the new policy's effectiveness against a new simulator by splitting the dataset into new subsets. In implementations, a plurality of policies are generated for the same random projection that was generated at block 402. After the plurality of policies are tested and evaluated, an average performance of the random projection is determined (block 418). In implementations, the average performance includes an average of the scores corresponding to each policy.

A new random projection is generated and the entire process is repeated with respect to the new random projection to determine an average performance of the new random projection (return to block 402). After a number of iterations, the top-performing projections are identified (block 420). For example, the average performances of the different random projections can be compared to identify the projections having relatively highest values. These top-performing projections each represent a relatively small set of highly relevant user-features that a learning algorithm can use to determine relatively effective advertisements to show to users.

### Implementation Example

The following discussion describes example techniques for automatic discovery of high-performance features for LTV optimization via low-variance random projection. The example techniques may be implemented via the environment 100 of FIG. 1, the system of FIG. 5, and/or any other suitable environment. The following algorithm presents detailed ways of determining various values discussed in the procedures above in accordance with one or more implementations. In at least some implementations, the algorithm may be implemented via computer-executable logic, such as by the service manager module 110.

The following defines terms used in the algorithm:

Let K be a dataset containing |K| recorded observation (s, a, s′, r)

where s is a set of features describing the current state of a
customer, a is an action, s′ is the new state of the customer,
and r is reward predictions;

Let N be the original dimensionality of states;
Let s(i) denote the i - th feature of state s;
Let min_{K}_{ᵢ}(p) be the minimum value of the p-th feature over elements in Kᵢ

where Kᵢ is a given subset of K;

Let max_{K}_{ᵢ}(p) be the maximum value of the p-th feature over elements in
Kᵢ;
Let μ_{K}_{ᵢ}(p) be the mean value of the p-th feature over elements in Kᵢ;
Let σ_{K}_{ᵢ}(p) be the standard deviation of the p-th feature over
elements in Kᵢ;
Let n be a target reduced dimensionality that is to be achieved;
Let T₁ be the number of candidate transformations to be evaluated;
Let T₂ be the number of trials used to evaluate each candidate

transformation approximately modeling the underlying MDP:
\hat{F}_{K}_{ᵢ}(s, a) → ( [symbol] ,\hat{r}), where [symbol] and \hat{r} are next state and
reward predictions;

Let \hat{Π}_{K}_{ᵢ} denote a policy trained with dataset Kᵢ: \hat{Π}_{K}_{ᵢ}(s) → a,

where a is an action; and

Let Γ ← Ø be a set of candidate compression operators and their

corresponding average performances.

The following algorithm is an example implementation of the techniques described above, and is not necessarily limited to the specific example provided by the following algorithm.

```
// In parallel, evaluate T₁ candidate compression operators:
for t = 1, . . . , T₁ do
  Let Rₜ be a (N × n) matrix with entries drawn from [symbol]  (0,1)
    // Evaluate average performance over T₂ synthetically -
generated MDPs
    for t = 1, . . . ,T₂ do
        Randomly split K into disjoint subsets K₁ and K₂
        Train simulator \hat{F}_{K}_{ᵢ}
        Collect all states in the tuples of K₂ into a set S⁰
        // Feature conditioning via log - transform, zscore,
rescaling, centering:
        for f = 1, . . . , N do
        Let S¹ (f) ← log(S⁰ (f) + minₛ⁰ (f) + 1)
        $Let {S}^{2} ( f ) ← \frac{{s}^{1} ( f ) - {μ}_{{s}^{1}} ( f )}{{σ}_{{s}^{1}} ( f )}$
        $Let {S}^{3} ( f ) ← \frac{{s}^{2} ( f ) - {min}_{{s}^{2}} ( f )}{{max}_{{s}^{2}} ( f ) - {min}_{{s}^{2}} ( f )}$
        Let S⁴ (f) ← S³ (f) − μₛ³ (f)
    end for
    // State compression via random projection operator Rₜ:
    for each state s ∈ S⁴ do
      ^{s}comp ← s × Rₜ // where we see s as a (1 x N) row vector
    end for
    Replace each state in K₂ with corresponding compressed form^{s}comp
    Train policy \hat{Π}_{K}_{₂}
    Use \hat{F}_{K}_{₁} to evaluate the performance of Jᵥ of policy \hat{Π}_{K}_{₂}:
      - States s generated by the simulator have their features conditioned
      as above and compressed using Rₜ, before being presented to policy
      \hat{Π}_{K}_{₂} (ŝ)
    end for
    Let Jₜ be the mean performance over {Jᵥ}, v ∈ {1, . . . , T₂}
end for
Return the top X% percentile best-performing compression operators in Γ
according to their estimates mean performances
```

### Example System and Device

FIG. 5 illustrates an example system generally at 500 that includes an example computing device 502 that is representative of one or more computing systems and/or devices that may implement the various techniques described herein. This is illustrated through inclusion of the service provider 102. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware element 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

Cloud 514 includes and/or is representative of a platform 516 for resources 518. Platform 516 abstracts underlying functionality of hardware (e.g., servers) and software resources of the cloud 514. Resources 518 may include applications and/or data that can be utilized while computer processing is executed on servers that are remote from the computing device 502. Resources 518 can also include services 520 provided over the Internet and/or through a subscriber network, such as a cellular or Wi-Fi network.

Platform 516 may abstract resources and functions to connect computing device 502 with other computing devices. Platform 516 may also serve to abstract scaling of resources to provide a corresponding level of scale to encountered demand for resources 518 that are implemented via platform 516. Accordingly, in an interconnected device embodiment, implementation of functionality described herein may be distributed throughout system 500. For example, the functionality may be implemented in part on computing device 502 as well as via platform 516 that abstracts the functionality of cloud 514.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method, comprising:
generating a random projection matrix that is usable to compress a dataset representing a plurality of features associated with one or more customers;
creating a simulator to model customer behavior based on a first subset of the plurality of features;
training a policy to determine which advertisements to present to a new customer based on a second subset of the plurality of features, the policy being trained by at least using the random projection matrix to compress the second subset of the plurality of features; and
evaluating a performance of the policy using the simulator to determine a level of the performance of the policy.

2. A computer-implemented method as recited in claim 1, further comprising, prior to using the random projection matrix to compress the second subset, transforming the second subset to enable comparison across different features included in the second subset.

3. A computer-implemented method as recited in claim 2, further comprising randomly splitting the plurality of features into the first subset and the second subset.

4. A computer-implemented method as recited in claim 1, wherein the first subset of the plurality of features is disjoint from the second subset of the plurality of features.

5. A computer-implemented method as recited in claim 1, further comprising iteratively repeating the creating, training, and evaluating operations using new subsets of the plurality of features to, in each iteration, create a new simulator, train a new policy, and evaluate the new policy with the new simulator.

6. A computer-implemented method as recited in claim 5, further comprising obtaining an average performance of the random projection matrix based on a plurality of the iterations.

7. A computer-implemented method as recited in claim 1, further comprising:
repeating the creating, training, and evaluating operations using different subsets of the plurality of features for each iteration;
measuring an average performance of the random projection matrix based on simulated performances of a plurality of policies;
generating a new random projection matrix;
repeating the creating, training, and evaluating operations using the new random projection matrix to obtain an average performance of the new random projection matrix based on simulated performances of a plurality of new policies; and
comparing the average performance of the random projection matrix to the average performance of the new random projection matrix.

8. A computer-implemented method as recited in claim 1, wherein the second subset is transformed by at least using one or more of a log-transform function, a zscore function, a rescaling function, or a centering function.

9. A computer-implemented method as recited in claim 1, further comprising:
repeating the generating, creating, training, and evaluating operations; and
identifying top-performing random projection matrices based on a comparison of performance evaluations of policies generated using respective random projection matrices.

10. A computing device, comprising:
one or more processors; and
a memory having instructions that are executable by the one or more processors to implement a feature discovery module that is configured to:
create a random projection that represents one or more of a transformation to or compression of a plurality of features associated with a customer;
split customer data into multiple subsets of data including a first subset and a second subset, the first subset being usable to generate a simulator configured to model customer behavior, the second subset being usable in conjunction with the random projection to generate a policy for determining which advertisements to present to the customer; and
evaluate the policy using the simulator to measure a performance of the policy.

11. A computing device as recited in claim 10, wherein the feature discovery module is further configured to:
create an additional random projection that is different than the first random projection;
split the customer data into multiple additional subsets of data including a third subset and a fourth subset, the third subset being usable to generate a new simulator configured to model the customer behavior, the fourth subset being usable to generate a new policy for determining which advertisements to present to the customer;
evaluate the new policy using the new simulator to measure a performance of the new policy.

12. A computing device as recited in claim 10, wherein the feature discovery module is further configured to compare the performance of the policy and the performance of the new policy to identify a top-performing policy.

13. A computing device as recited in claim 10, wherein the policy is generated based on a transformation of the second subset, the transformation being based on one or more feature-conditioning functions that cause features in the second subset to be one or more of approximately Gaussian-distributed, bounded with a controlled mean and variance, or centered.

14. A computing device as recited in claim 10, wherein the random projection comprises a compressed-sensing matrix that projects the second subset onto a lower-dimensional subspace.

15. A computing device as recited in claim 10, wherein:
the second subset is transformed to generate a transformed second subset; and
the random projection is applied to the transformed second subset to reduce a number of features included in the transformed second subset.

16. Computer-readable storage memory comprising stored instructions that are executable by a computing device to implement a feature discovery module configured to perform operations comprising:
generating, based on a first subset of a plurality of features describing one or more customers, a simulator to model customer behavior;
training a policy to determine which advertisements to present to a customer based on a second subset of the plurality of features, the policy being trained by at least applying a random projection matrix to the second subset to transform the second subset into a new subset of features that is relatively smaller than the second subset; and
evaluating a performance of the policy by using the simulator to simulate user responses to the policy.

17. Computer-readable storage memory as recited in claim 16, wherein the first subset and the second subset are disjoint.

18. Computer-readable storage memory as recited in claim 16, wherein the operations further include iteratively repeating the generating, training, and evaluating operations using new subsets of the plurality of features to, in each iteration, create a new simulator, train a new policy, and evaluate the new policy with the new simulator.

19. Computer-readable storage memory as recited in claim 18, wherein the operations further include obtaining an average performance of the random projection matrix based on a plurality of the iterations.

20. Computer-readable storage memory as recited in claim 16, wherein the operations further include generating the random projection matrix to represent an arbitrary set of baseline features describing the one or more customers.
